(19) United States
(12) Patent Application Publication
(10) Pub. No.: US 2026/0099261 A1
(43) Pub. Date: Apr. 9, 2026

(54) LOAD BALANCING AGENT FOR LOAD DISTRIBUTION

(71) Applicant: Dell Products L.P., Round Rock, TX (US)

(72) Inventors: Krishna Deepak Nuthakki, Bangalore (IN); Jeffrey Wilson, Franklin, MA (US); Arieh Don, Newton, MA (US)

(73) Assignee: Dell Products L.P., Round Rock, TX (US)

(21) Appl. No.: 18/908,997

(22) Filed: Oct. 8, 2024

(51) Int. Cl. G06F 3/06

(52) U.S. Cl. CPC G06F 3/0635; G06F 3/0604; G06F 3/067

(57) ABSTRACT

A method is provided, comprising: detecting a load-balancing event; selecting a given array port in a storage system; selecting a first logical unit number (LUN) in the storage system; identifying a plurality of host ports in a host device; and causing a respective LUN-specific priority status of each of the plurality of host ports, with respect to the first LUN, to have a first value, the first value being a value that would cause a path selection software in the host device to choose another array port in the storage system over the given array port for transmission of input-output (I/O) requests directed to the first LUN.

### BACKGROUND

A distributed storage system may include a plurality of storage devices (e.g., storage arrays) to provide data storage to a plurality of nodes. The plurality of storage devices and the plurality of nodes may be situated in the same physical location, or in one or more physically remote locations. The plurality of nodes may be coupled to the storage devices by a high-speed interconnect, such as a switch fabric.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to aspects of the disclosure, a method is provided, comprising: detecting a load-balancing event; selecting a given array port in a storage system; selecting a first logical unit number (LUN) in the storage system; identifying a plurality of host ports in a host device; and causing a respective LUN-specific priority status of each of the plurality of host ports, with respect to the first LUN, to have a first value, the first value being a value that would cause a path selection software in the host device to choose another array port in the storage system over the given array port for transmission of input-output (I/O) requests directed to the first LUN.

According to aspects of the disclosure, a system is provided, comprising: a memory; and at least one processor that is operatively coupled to the memory, the at least one processor being configured to perform the operations of: detecting a load-balancing event; selecting a given array port in a storage system; selecting a first logical unit number (LUN) in the storage system; identifying a plurality of host ports in a host device; and causing a respective LUN-specific priority status of each of the plurality of host ports, with respect to the first LUN, to have a first value, the first value being a value that would cause a path selection software in the host device to choose another array port in the storage system over the given array port for transmission of input-output (I/O) requests directed to the first LUN.

According to aspects of the disclosure, a non-transitory computer-readable medium storing one or more processor executable instructions, which when executed by at least one processor, cause the at least one processor to perform the operations of: detecting a load-balancing event; selecting a given array port in a storage system; selecting a first logical unit number (LUN) in the storage system; identifying a plurality of host ports in a host device; and causing a respective LUN-specific priority status of each of the plurality of host ports, with respect to the first LUN, to have a first value, the first value being a value that would cause a path selection software in the host device to choose another array port in the storage system over the given array port for transmission of input-output (I/O) requests directed to the first LUN.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1A is a diagram of an example of a system, according to aspects of the disclosure;

FIG. 1B is a diagram of an example of a storage system, according to aspects of the disclosure;

FIG. 2 is a diagram of an example of a port map, according to aspects of the disclosure;

FIG. 3A is a diagram of a port map portion, according to aspects of the disclosure;

FIG. 3B is a diagram of a port map portion, according to aspects of the disclosure;

FIG. 4A is a diagram of an example of a process, according to aspects of the disclosure;

FIG. 4B is a diagram of an example of a process, according to aspects of the disclosure;

FIG. 4C is a diagram of an example of a process, according to aspects of the disclosure; and

FIG. 5 is a diagram of an example of a computing device, according to aspects of the disclosure.

### DETAILED DESCRIPTION

In networking, ALUA (Asymmetric Logical Unit Access) is a protocol used in storage area networks (SANs) to optimize how devices access storage. It is primarily used in environments with multiple storage controllers (often called storage processors), which can be found in redundant or high-availability storage systems. In general, ALUA enables the storage system to designate one or more controllers (i.e., storage processors or ports in the storage processor) as the “optimized” or active path, which provides better performance and faster access. Other paths in the storage system may be labeled as non-optimized and used only when the optimized path is unavailable (due to failure or maintenance). ALUA works with multipathing software, which manages multiple paths between the host and storage devices. The software uses ALUA to determine which path is preferred at any given time and can automatically switch paths if a failure occurs, ensuring continuous access.

The present disclosure provides a method for port load balancing. The method can be used to enhance the existing ALUA specification, or it can be used independently. The method permits automated shifting of I/O workload between ports following recommendations of an external tool which load balances I/Os from multiple initiators from multiple host devices while incorporating the knowledge which worldwide name (WWN) belongs to which host. The method permits automated changes of the ALUA states on each port of a storage system, for each LUN. Unlike, the current specification of ALUA, the method enables the same port of a storage system to be set to “optimized” priority status for a first logical unit number (LUN) in the storage system and to a “non-optimized” priority status for a different LUN. In the context of ALUA, the priority status discussed herein is also referred to as ALUA Asymmetric Access State (AAS).

This method permits each LUN in a storage system to have a different (or separate) priority status with respect to the same port in a given host device and/or the same array port. For example, in the given host device, port 1 may have an “optimized” priority status with respect to LUN 1 in the storage system and a “non-optimized” priority status with respect to LUN 2 in the storage system. Similarly, port 2 in the given host may have a “non-optimized” priority status with respect to LUN 1 and an “optimized” priority status with respect to LUN 2.

When the priority status of a port is set to “optimized” with respect to a given LUN, this port is going to be given a preference for the transmission of IOs to the given LUN over ports whose priority status is “non-optimized”. In this regard, in the above example, the given host device will transmit IOs for LUN 1 over port 1, unless port 1 is unavailable, in which case the given host device may resort to using port 2. Similarly, in the above example, the given host device will transmit IOs for LUN 2 over port 2, unless port 2 is unavailable, in which case the given host device may resort to using port 1.

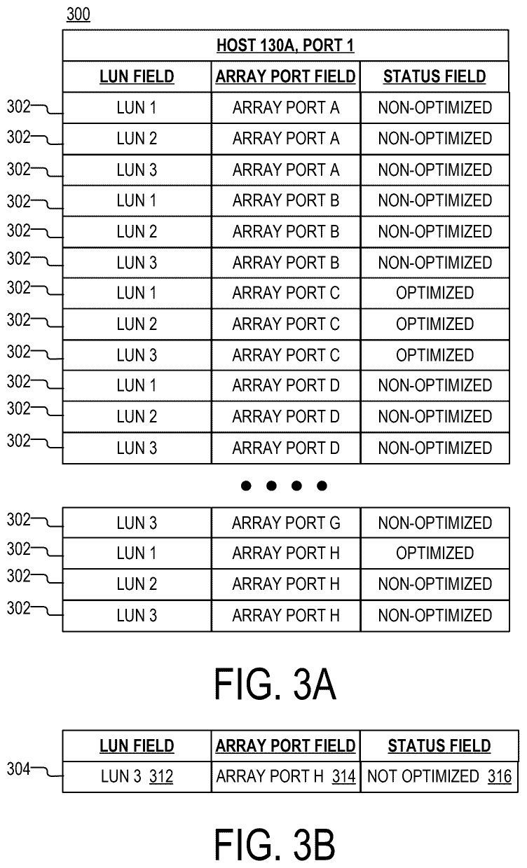

The term “ALUA priority status” is used herein for ease of description. As noted above, the method involves assigning a LUN-specific priority status for each (or any) of the ports in a host device. The priority status of a particular port in a given host device, with respect to a particular LUN, may be set to either an “optimized” value or a “non-optimized” value. In some implementations, the implementation of the priority status assignment may be completely unrelated to ALUA. For example, the priority status assignment may be performed in the multipath agent of a host device by upgrading the multipath agent to: (i) store a database in the memory of the host device that lists the priority status of any port in the host device with respect to different LUNs in the storage system (e.g., see map portion 300 shown in FIG. 3), and (ii) use the database to discriminate between different ports in the host device when it comes to the transmission of communications to a particular LUN in the storage system.

The storage system may be an enterprise storage system that is connected to different servers in a data center via a Fibre Channel (DC) network. In this regard, the given host device from the above example may be a server that is running one or more applications that use different LUNs in the storage system for their data storage needs. In this regard, each of the ports in the host device may have a different worldwide name (WWN). Different ports in the host device may present themselves to the storage system through their WWNs. However, because the storage system is connected to multiple host devices, in a conventional setting, the storage system would be unaware of which ports belong to the same host device. In other words, a conventional storage system would see a plurality WWNs that belong to different ports, but it would lack awareness of which ports belong to the same host device.

Unlike conventional storage systems, the storage system that is the subject of the present disclosure is configured to identify all (or at least some) ports through which the given host device (from the above example) is connected to the storage system. After which, the storage system may set the priority status of one of the ports to “optimized” while setting the priority status of the rest of the identified ports to “non-optimized”. Although, in the present example, no more than one of the identified ports is set to an “optimized” priority status for a particular LUN, in an alternative implementation, more than one of the identified ports may be set to an “optimized” priority status for the same LUN.

In some respects, each port of a given host device may be mapped by the FC network to a corresponding port in the storage system. The mapping may be performed by the switches and other equipment which constitutes the FC network connecting the given host device to the storage system. The 2-tupple consisting of a host port and a storage system port can also be referred to as a “communications path” that connects the host device to the storage system. As is discussed further below, the LUN-specific priority status of a host device port may apply to a particular network path originating at the host device port and ending at a specific storage array port, such that there can be multiple LUN-specific priority assignments for different network paths originating from the host device port and terminating at different storage array ports.

As is discussed further below, by setting a LUN-specific status of each (or at least one) of the ports, on each (or at least one) of the host devices that are connected to the storage system, the storage system may effectively balance the load that is exerted on each (or at least one) of its ports. As can be readily appreciated, balancing the load on the ports of a storage system may help improve the latency (or efficiency) at which the storage system fulfills I/O requests. Accordingly, the method for LUN-specific status assignment to ports, which is disclosed herein, is advantageous because it can improve the operation of storage systems.

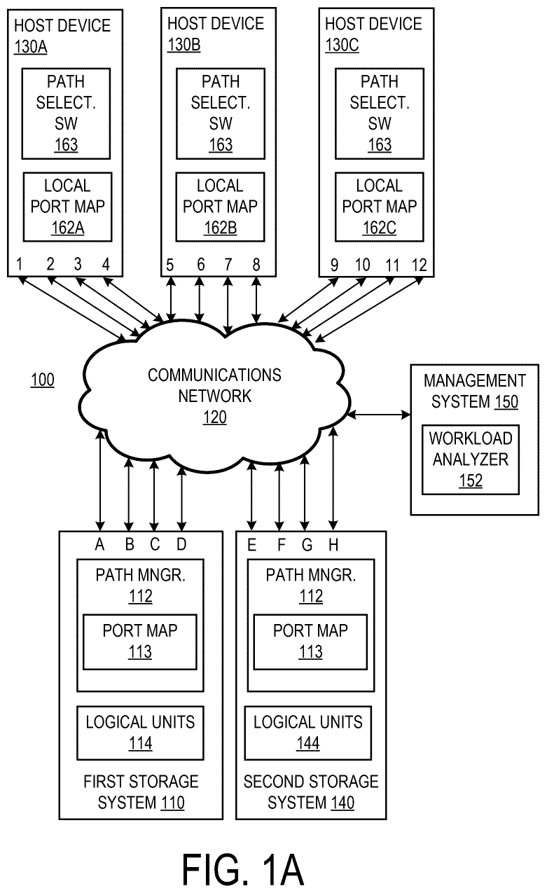

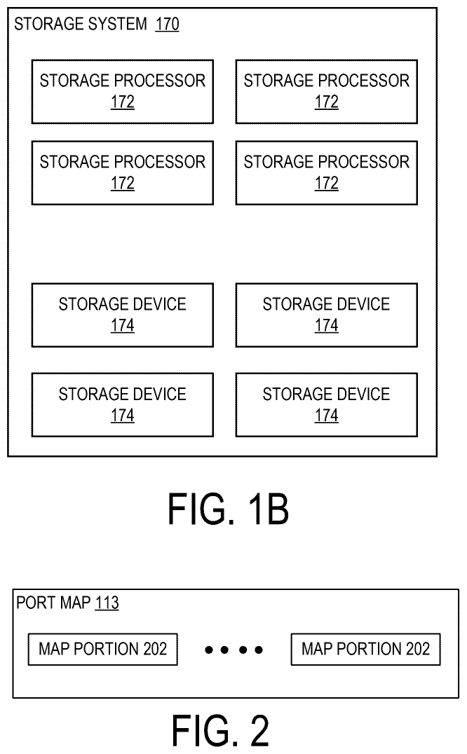

In some implementations, the LUN-specific status assignment to individual ports in a host device may be performed by an external tool or other software. The external tool (e.g., workload analyzer (WLA) 152, shown in FIG. 1A) or other software may be executed on a management console (e.g., management system 150, shown in FIG. 1A) that is part of the storage system and/or any other computing device that is part of the storage system. In some implementations, to perform the LUN-specific assignment, the management console may leverage the Fabric Device Management Interface (FDMI) protocol that is implemented in the switches of the FC network connecting host devices to the storage system. The FDMI protocol may provide detailed information about Host Bust Adapter (HBA), including vendor information, the model, or the firmware version of the host device. Importantly, for each HBA, the FDMI protocol may also provide the hostname of the host device of which the HBA is part. Furthermore, for each port in an HBA, the FDMI protocol may provide the WWN of the host devices. Stated succinctly, the capabilities afforded by the HBA protocol enable the external tool to discover all ports that connect a given host device to the storage network by querying the FDMI interface of one or more switches in the FC network and processing the returned information to cross-reference port WWN's with the host device names that belong to the host devices of which the port's HBA is part.

As used herein, the terms “LUN” and “logical unit (LU) are used interchangeably. In general, LUs in a storage system are referenced by their LUNs and for this reason, the terms are used interchangeably. An LU in a storage system may be a data volume and/or any other suitable type of virtualized representation of storage.

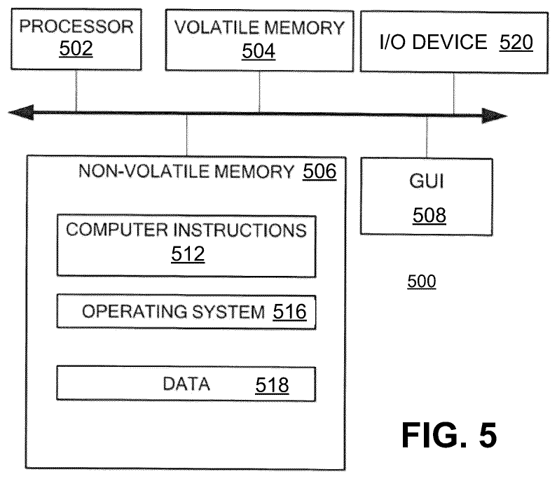

FIG. 1A is a diagram of an example of a system 100, according to aspects of the disclosure. As illustrated, system 100 may include storage systems 110 and 140 that are coupled to a plurality of host devices 130A-C and a management system 150 via a communications network 120. According to the present example, each of the host devices 130A-C is a server that is configured to access the storage system 110 and/or storage system 140 for its data storage needs. Additionally or alternatively, in some implementations, each of the host devices 130A-C may be the same or similar to the computing device 500, which is discussed further below with respect to FIG. 5. Management system 150 may include any suitable type of computing device that is arranged to manage one or more aspects of the operation of at least one of storage systems 110 and 140. Management system 150 may be the same or similar to the computing device 500, which is discussed further below with respect to FIG. 5. Storage system 110 may include any suitable type of storage system. In one example, storage system 110 may be the same or similar to storage system 170, which is discussed further below with respect to FIG. 1B. Storage system 140 may include any suitable type of storage system. In one example, storage system 140 may be the same or similar to storage system 170, which is discussed further below with respect to FIG. 1B.

FIG. 1B is a diagram of an example of a storage system 170, according to aspects of the disclosure. As illustrated, the storage system 170 may include a plurality of storage processors 172 and a plurality of storage devices 174. Each of the storage devices 174 may include a hard disk (HD), a solid-state drive (SSD), a non-volatile random-access memory (NVRAM) device, a non-volatile memory express (NVME) device, and/or any other suitable type of storage devices. Each of the storage processors 172 may include a computing device, such as the computing device 500, which is discussed further below with respect to FIG. 500. Each of the storage processors 172 may be configured to execute I/O requests that are received at storage system 170 from computing devices 130A-C by reading or writing data to the storage devices 174.

Returning to FIG. 1A, storage system 110 may include a plurality of logical units (LUs) 114, and storage system 140 may include a plurality of LUs 144. Each of LUs 144 may be a copy of a different one of LUs 114. In one example, storage systems 110 and 140 may be configured to operate in an active-active or active-passive configuration. When storage systems 110 and 140 operate in active-active configuration, each of host devices 130A-C is permitted to write to either one of the storage systems 110 and 140, after which the write is propagated to the other one of storage systems 110 and 140 before the write is acknowledged. When storage systems 110 and 140 operate in active-passive configuration, each of host devices 130A-C is permitted to write to only one of storage systems 110 and 140, and the write is propagated to the other one of storage systems 110 and 140 after the write is acknowledged. In the present example, any of the LUs in storage system 110 is given the same LUN as the copy of the same LU that is present storage system 140. However, in an alternative implementation, a LU may be given a different LUN than the LU's copy. Although, in the present example, system 100 includes both storage systems 110 and 140, in an alternative implementation, system 100 may include only one of the storage systems 110 and 140.

Storage systems 110 and 140 include a plurality of ports, which are herein enumerated ports A-H, wherein ports A-D are part of storage system 110 and ports E-H are part of storage system 140. Although, in the present example, storage systems 110 and 140 include four ports each, it will be appreciated that in many practical applications, a storage system may have a much larger number of ports. Each port may be a port that is provided by an HBA in one of the storage processors in storage system 110 or storage system 140. Each of storage systems 110 and 140 may be configured to execute a respective instance of a path manager 112. According to the present example, the path manager is an ALUA module (or “ALUA controller”). However, alternative implementations are possible in which path manager 112 is any software that is configured to assist the host devices 130A-C, and or communications network 120, in their path selection activities.

As used throughout the disclosure, the terms “storage system” and “storage array” are used interchangeably. Under the nomenclature of the present disclosure, each of the ports A-H is also referred to as “an array port”. Under the nomenclature of the present disclosure, each of the ports 1-12 is also referred to as “a host port”.

Each of storage systems 110 and 140 may be configured to store a port map 113. Port map 113 in any of storage systems 110 and 140 may be stored in the memory of a storage processor that is part of the storage system and/or at any other storage location. As illustrated in FIG. 2, port map 113 may include a plurality of portions 202. Each map portion 202 may correspond to a specific host device (hereinafter “the map portion's corresponding host device”). For each of the plurality of ports in the map portion's host device, a map portion 202 may include a plurality of LUN-specific priority status indicators, wherein each LUN-specific priority status indicator indicates whether the priority status of the port with respect to a given LUN (in one of the storage systems 110 and 140) is “optimized” or “non-optimized”. Port map 113 may be generated by a workload analyzer (WLA) 152, which is executed by management system 150. Additionally or alternatively, port map 113 may be generated by a storage processor in one of the storage systems 110 and 140, or any other computing device. The present disclosure is not limited to any specific entity generating the port map 113 and/or the port map 113 being stored in one storage location. In one implementation, storage systems 110 and 140 may use the same copy of port map 113 that is stored in the memory of management system 152, as opposed to each of storage systems 110 and 140 having a separate copy of port map 113.

FIG. 3A is a diagram of a port map portion 300, according to aspects of the disclosure. Port map portion 300 may be the same or similar format to any of portions 202 (shown in FIG. 2). According to the present example, portion 300 corresponds to port 1 of host device 130A. Under the nomenclature of the present example, host device 130A is referred to as “the corresponding host device” of portion 300 and/or any of the entries 302 in portion 300. By the same token, port 1 is referred to as “the corresponding host port” of portion 300 and/or any of the entries 302 in portion 300.

FIG. 3B is a diagram of an example of an entry 304, according to aspects of the disclosure. Entry 304 may be the same or similar to any of entries 302 that constitute the port map portion 300. In this regard, the corresponding port of entry 304 may be port 1 of host device 130A.

In one aspect, FIG. 3B illustrates in further detail an example of one possible implementation of the entries in port map portion 300. As illustrated, entry 304 may include a LUN field 312, an array port field 314, and a status field 316. Field 312 may include an indication of a LUN; field 314 may include an indication of a portion in one of the storage systems 110 and 140 (i.e., an array port); and field 316 may include an indication of priority status.

In another aspect, FIG. 3B illustrates that entry 304 corresponds to a network path starting at the entry's 304 corresponding host port (i.e., port 1) and ending at the entry's storage array port (i.e., port H). The value of the status field 316 identifies the LUN-specific priority status of the entry's 304 corresponding network path, with respect to the LUN identified in field 312 (i.e., LUN 3). Put differently, the value of the status field 316 identifies the LUN-specific priority status of the entry's 304 corresponding network port (i.e., port 1), with respect to the LUN identified in field 312 (i.e., LUN 3) and the array port identified in field 314 (i.e. port H).

In yet another aspect, FIGS. 3A-B illustrate that each of the entries 302 in port map 113 may identify a LUN, a respective network path as well as the respective status of the network path, with respect to the LUN. Put differently, each of the entries may identify the respective status, with respect to the LUN identified in the entry, of the entry's corresponding host port, The value that is stored in the status field of each entry may be either “optimized” or “non optimized”. When the value is set to “optimized”, this may cause the entry's corresponding host device to choose the array port identified in the entry (over other array ports in the same storage system) to receive I/O requests directed to the volume identified in the entry. When the value is set to “optimized”, this may cause the entry's corresponding host device to pass over (or ignore) the array port identified in the entry (in favor of other array ports in the same storage system) for receiving I/O requests directed to the volume identified in the entry.

Although in the example of FIGS. 3A-B, port map 113 is implemented as a table, it will be understood that the present disclosure is not limited to any specific implementation of port map 113. For example, port map 113 may be implemented as a tree structure, a file, a database object, and/or any other suitable type of data structure or a set of data structures. It will be understood that the present disclosure is not limited to any specific implementation of port map 113.

Returning to FIG. 1A, host devices 130A-C may be configured to store, in their respective memories, local port maps 162A-C. Each of the local port maps 162A-C may be a proper subset set of the set of portions 202 that constitutes the port map 113. Each of the local port maps 162A-C may be provided one of the host devices 130A-C by path manager 112. In other words, in one example, the WLA 152 may generate the port map 113 and provide the port map 113 to storage systems 110 and 140, after which, a different portion of port map 113, may be communicated by storage systems 110 and/or 140 to each of host devices 130A-C. In one example, local port map 162A may be stored in the memory of host device 130A and it may include those portions 202 that correspond to ports in host device 130A; local port map 162B may be stored in the memory of host device 130B and it may include those portions 202 that correspond to ports in host device 130B; and local port map 162C may be stored in the memory of host device 130C and it may include those portions 202 that correspond to ports in host device 130C.

Host device s 130A-C may be configured to execute instances 163A-C of a path selection software. The path selection software may include one or more of a multinetwork path agent, a network driver, and/or any other suitable type of software. According to the present example, instance 163A is executed on host device 130A, instance 163B is executed on host device 130B, and instance 163C is executed on host device 130C. In operation, instance 163A may detect that there is an I/O request directed to a given LUN in storage system 110 that is waiting to be transmitted to storage system 110. Next, instance 163A may select a source port in host device 130A. Next, instance 163A may select a network part starting at the selected source port and ending at one of the array ports in storage system 110. And finally, the I/O request may be transmitted over the selected network path. In selecting the network path, instance 163A may give preference to a network path whose LUN-specific priority status with respect to the given LUN is set to “optimized” over network paths whose LUN-specific priority status, with respect to the given LUN, is set to non-optimized. In some implementations, instance 163A may select a network path whose LUN-specific priority status, with respect to the given LUN, is set to “optimized” and ignore network paths whose LUN-specific priority status, with respect to the given LUN, is set to “non-optimized.” Additionally or alternatively, in some implementations, instance 163A may select a network path whose LUN-specific priority status, with respect to the given LUN, is set to “non-optimized” only if no network path is available whose LUN-specific priority status with respect to the given LUN is set to “optimized”.

Management system 150 may be configured to execute the workload analyzer (WLA) 152. Although, in the present example, WLA 152 is implemented in software, alternative implementations are possible in which WLA 152 is implemented in hardware or as a combination of software and hardware.

In one example, WLA 152 may be configured to change the respective LUN-specific priority status of port 1 in host device 130A (or another host device), with respect to a first LUN that is at least in part hosted by storage system 110. The respective priority status may be changed from “optimized” to “non-optimized”. The change may be specific to port A (or another port) in storage system 110. In this regard, this operation may also be referred to as “setting to “non-optimized” the LUN-specific priority status, with respect to the first LUN, of the network path starting at port 1 and ending at port A”. The change may cause host device 130A to choose another port in storage system 110 (over port A) for the transmission of I/O requests directed to the first LUN, which originate from port 1. This means that the other port would be given priority over port A when host device 130A selects a destination port (in storage system 110) for the transmission of I/O requests directed to the first LUN. However, port A may still be selected under exigent circumstances. In most practical applications, however, if the host device is configured correctly, port A would be used very rarely, if at all, to receive I/O requests directed to the first LUN.

The scope of the above operation is limited in two ways. First, the operation affects only the transmission of I/O requests that originate from port 1. Executing the operation does not affect the transmission of I/O requests that originate from other ports in host device 130A. And second, the operation affects only I/O requests that are transmitted to the first LUN. The operation would not affect I/O requests directed to a second LUN in storage system 110. For example, if the priority status of the network path starting at port 1 and ending at port A is set to optimized, with respect to the second LUN, port A may be given a preference for receiving I/O requests for the second LUN that originate from port 1.

The above operation may be completed in multiple ways. In one example, the above operation may be performed as follows. WLA 152 may transmit to storage system 110 (i.e., to any given one of the storage processors in storage system 110) an instruction to update port map 133. The instruction may include an identifier of port 1, an identifier of port A, the LUN, as well as an indication of the new value for the priority status of port 1 (i.e., non-optimized). The instruction may be executed by storage system 110. To execute the instruction, storage system 110 (or the given storage processor) may identify portion 202 of port map 113 that corresponds to port 1 of host device 130A. Next, storage system 110 (or the given storage processor) may identify an entry 302 in the identified portion 202 which includes an identifier of port 1 and an identifier of port A. Next, storage system 110 may update the identified entry 302 by overwriting the current value in the priority status field of the identified entry with the value of “non-optimized”. Next, storage system 130 may propagate the update to host device 130A. The propagation may be performed by using the ALUA protocol or in a similar manner. Specifically, storage system 110 (or the given storage processor) may transmit an instruction to host device 130A to synchronize the state of local port map 162A in accordance with the update. The instruction may include an identifier of port 1, an identifier of port A, and an indication of the new priority status (i.e., non-optimized), with respect to the first LUN, of the network path starting at port 1 and ending at port A. Upon receiving the instruction, host device 130A may update local port map 162A to indicate that the priority status of the network path is now “non-optimized”.

As can be readily appreciated, the phrases “changing the priority status of a host port, with respect to a particular LUN and array port” and changing “the priority status of an array port, with respect to a particular LUN and host” are synonymous. In the above example, the priority status of an array port is changed by updating a data structure that is maintained at the storage system. Specifically, in the above example, the priority status of array port A with respect to port 1 and LUN 1 is changed by updating the port map 113.

In another example, the above operation may be completed as follows. WLA 152 may transmit an instruction to update the priority status, with respect to the first LUN, of the network path starting at port 1 and ending at port A. The instruction may include an identifier of port 1, an identifier of port A, and an indication of the new priority status (i.e., non-optimized), with respect to the first LUN, of the network path starting at port 1 and ending at port A. Upon receiving the instruction, host device 130A may update local port map 162A to indicate that the priority status of the network path is now “non-optimized”. In this example, the priority status update may be performed by WLA 152, without involving the storage processors in storage system 110. In some implementations, the instruction may be transmitted to a multipath agent, such as PowerPath™, which is sold and marketed by the Dell Corporation of Round Rock, TX. In such implementations, updating the priority status, with respect to the first LUN, of the network path starting at port 1 and at port A from optimized to non-optimized status, may be accomplished by transmitting to the multipath agent an instruction to transition the path to an “AutoSTBY” state.

In some implementations, storage system 110 may be configured to implement a mechanism for backward compatibility. Specifically, before transmitting an instruction to a host device to update its local port map 162 to reflect a new LUN-specific status assignment to a particular host port, storage system 110 may identify the operating system (OS) of the host device. For example, the storage system 110 may identify the version number, build number, and/or other information about the OS by using any suitable type of OS by using any suitable type of OS fingerprinting technique. Next, the storage system 110 may determine if the host device supports LUN-specific priority status assignments for host ports or just regular ALUA assignments. When the host device supports LUN-specific priority status assignments, storage system 110 may transmit an instruction to the host device to synchronize the state of local port map 162A in accordance with the update. The instruction may include an identifier of port 1, an identifier of port A, and an indication of the new priority status (i.e., non-optimized), with respect to the first LUN, of the network path starting at port 1 and ending at port A. When the host device does not support LUN-specific port assignment, storage system 110 may transmit to the storage device a conventional ALUA command (or message) to update the priority status assignment for the part starting at port 1 and ending at port A for all LUNs in storage system 110. Alternatively, in some implementations, if the host device does not support LUN-specific priority status assignments, the host device may set the LUN-specific priority status of a port across the board (i.e., for all LUNs) when receiving a command to set a priority status for a particular LUN.

In the examples above, the LUN-specific priority status of a port is changed from “optimized” to “non-optimized”. However, the same mechanism can be used to change the priority status of a port from “non-optimized” to “optimized”. In the latter case, any instructions that are transmitted to a host device or storage processor may be contain “optimized” as the new priority status value, rather than “non-optimized”. Any actins that are ascribed to being performed by “a storage system” may be performed by one or more storage processors or other computing devices that are part of the storage system.

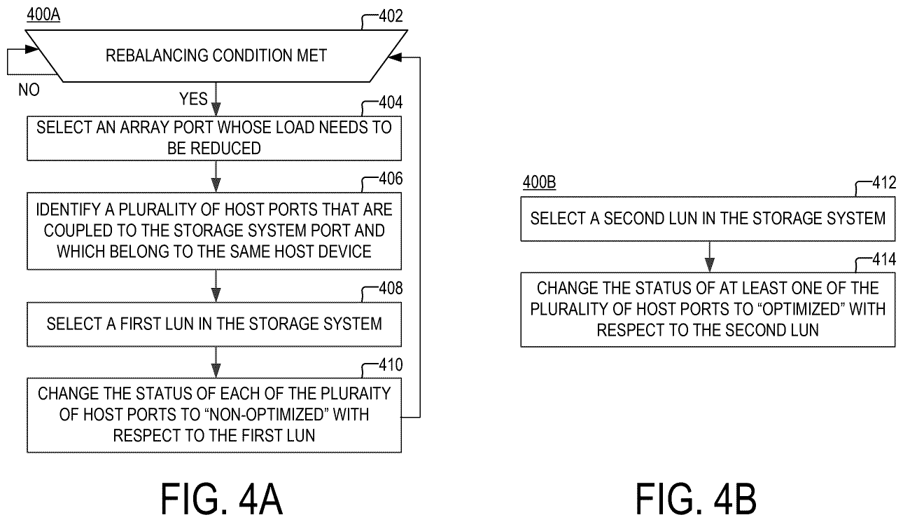

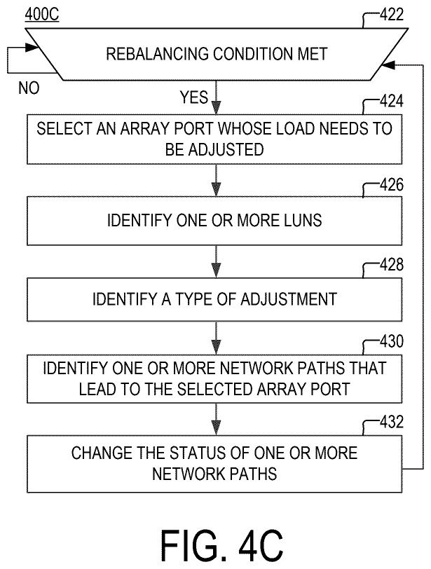

FIG. 4A is a flowchart of an example of a process 400A, according to aspects of the disclosure. According to the present example, process 400A is executed by WLA 152. However, the present disclosure is not limited to any specific entity or set of entities executing process 400A.

At step 402, WLA 152 determines if a rebalancing condition is met. According to the present example, the rebalancing condition is met when the load on one or more ports in storage system 110 and/or storage system 140 exceeds a predetermined threshold. However, the present disclosure is not limited to any specific rebalancing condition. For example, the rebalancing condition may be satisfied when a specific user input is received (i.e., user input instructing WLA 152 to load-balance the port) or a when a timer is triggered. If the rebalancing condition is met, process 400A proceeds to step 404. Otherwise, step 402 is repeated.

At step 404, WLA 152 selects a port in one of storage systems 110 and 140 whose load needs to be reduced. In one example, the selected port may be one whose load exceeds a predetermined threshold. However, the present disclosure is not limited to any specific selection criteria. For example, the port may be selected based on user input (i.e., user input identifying the port) and/or in any other suitable manner. In the present example, the storage system of which the selected port is part is referred to as “the given storage system”.

At step 406, WLA 152 identifies a plurality of host ports that are coupled to the array port that is selected at step 404. The plurality of host ports may be part of the same host device (e.g., one of host devices 130A-C). In some implementations, the plurality of host ports may include all ports in particular host device that are coupled to the given storage system via communications network 120. As noted above, the plurality of host ports may be discovered by using the FDMI protocol to query one or more switches in the communications network 120.

At step 408, WLA 152 selects a first LUN that is, at least in part, hosted by the given storage system. In some implementations, the first LUN may be selected using a round-robin algorithm, such that a different first LUN is selected at each consecutive execution of step 408, until all first LUNs in the given storage system, at which point the first LUN in the given storage system may be selected again at the next execution of step 408. However, the present disclosure is not limited to any specific method for selecting the LUN. For example, in some implementations, the first LUN may be selected based on user input identifying the port.

At step 410, WLA 152 causes the respective first LUN-specific priority status, with respect to the first LUN (identified at step 408), of each of a plurality of network paths to be set to the “non-optimized” value. Each of the plurality of network paths starts at the storage system port (selected at step 404) and ends at a different one of the host ports (identified at step 406). The plurality of network paths includes as many network paths as there are host ports in the plurality of host ports (identified at step 406). Executing step 408 may include: (i) identifying a subset of the plurality of network paths whose priority status is “optimized” and (ii) changing the priority status of each of the network paths in the subset to “non-optimized”. Executing step 408 may ensure that the storage system port (selected at step 404) would not be given preference (for the first LUN) by any of the ports in the host device that are used to transmit I/O requests to the storage system, which in turn would release at least some of the load experienced by the storage system port

[symbol]

FIG. 4A is provided as an example only. At least some of the steps in process 400A may be performed in a different order or in parallel. In this regard, in some implementations, the first LUN may be selected before the plurality of host ports is identified. In such implementations, the plurality of host ports may include all host ports from which the first LUN is visible. For example, the switches in communications network 120 may support zoning. Accordingly, any of the switches in communications network 120 may store in its memory a map that identifies which host ports on a given host device are permitted to communicate with the array port (selected at step 404). Furthermore, the given storage system may implement what is herein referred to as “masking”. Specifically, the given storage system (or one or more computing devices that are part of it) may store in its memory a data structure that identifies which host ports the LUN is visible to. In this regard, the selection of the plurality of host ports (at step 406) may be performed by executing the following sub-steps. First, WLA 152 may select one of the host devices 130A-C that are coupled to storage array 110. Next, WLA 152 may identify a first set of host ports on the selected host device, which are permitted by the network's 120 zoning policies to communicate with the array port (selected at step 404). The host ports may be identified by monitoring the communications of the array port to identify which host ports the array port receives messages from or by querying the switches in network 120. Next, WLA 152 may use the FMDI interface of network 120 to identify a plurality of host ports that are part of the selected host device. Next, WLA 152 may process each of the array ports in the first set to determine if the host port is permitted by the masking policies of the given storage system to communicate with the LUN (selected at step 408). And finally, the WLA 152 may include each of the host ports that are permitted to communicate with the LUN into a second set of host ports, wherein the second set constitutes the plurality of host ports that is selected at step 406.

So, in some implementations, process 400A may be executed as follows: first WLA 152 may select an array port whose load needs to be reduced (e.g., an array port that is experiencing a load exceeding a predetermined threshold), next WLA 152 may select a LUN that is accessible from the array port, next WLA 152 may select a host device, next WLA 152 may identify all host ports in the selected host device to which the selected LUN is visible, and finally, WLA 152 may set all (or at least some) of the selected host ports to “non-optimized priority status” with respect to the pair consisting of the selected LUN and selected array port. Setting all of the host ports to non-optimized priority status may help reduce the load on the selected array port as it would effectively have the effect of diverting all traffic for the LUN, which originates from the host device, to other ports in the given storage system (or another storage system, if a copy of the LUN is also maintained at the other storage system). Also, setting only some of the host ports to non-optimized status may also help reduce the load on the array port, depending on the algorithm for path selection to the LUN that is employed by the multipath agent of the host device.

FIG. 4B is a flowchart of an example of a process 400B. Process 400B may be executed concurrently with process 400A. At step 412, storage identifies a second LUN that is provided, at least in part, by the same storage system as the first LUN. At step 414, changes to “optimized” the LUN-specific priority status, with respect to the second LUN, of a network path that originates at one of the host ports (identified at the most recent iteration of step 406) and ends at the storage array port (selected at the most recent iteration of step 404).

FIG. 4C is a flowchart of an example of a process 400C, according to aspects of the disclosure. According to the present example, process 400C is executed by WLA 152. However, the present disclosure is not limited to any specific entity or set of entities executing process 400B.

At step 422, WLA 152 determines if a rebalancing condition is met. Step 412 may be performed in the manner discussed above with respect to step 402 of process 400A. If the rebalancing condition is met, process 400B proceeds to step 414. Otherwise, step 412 is repeated.

At step 424, WLA 152 selects an array port in one of the storage systems 110 and 140 whose load needs to be adjusted. The present disclosure is not limited to any specific selection criteria. By way of example, the selected array port may be one that is experiencing the highest load among all ports in storage system 110 (and/or storage system 140). As another example, the selected array port may be one that is experiencing the lowest load among all ports in storage system 110 (and/or storage system 140)

At step 426, WLA 152 identifies one or more LUN that are at least in part provided by the storage system of which the array port (selected at step 424) is part.

At step 428, WLA 152 identifies the type of adjustment that needs to be performed on the load of the selected port. For example, if the selected port is one experiencing the highest load among all ports in storage system 110 (or storage system 140), WLA 152 may determine that the load on the selected port needs to be decreased. As another example, if the selected port is one experiencing the lowest load among all ports in storage system 110 (or storage system 140), WLA 152 may determine that the load on the selected port needs to be LUN.

At step 430, WLA 152 identifies one or more network paths that lead to the array port (selected at step 424). Each of the network paths may start in one of the host ports in any of storage devices 130A-C and end at the array port (selected at step 424).

At step 3, WLA 152 changes the LUN-specific priority status for one or more network paths that lead to the array port (selected at step 424). If the type of adjustment (identified at step 428) involves increasing the load on the array port, the LUN-specific priority status of the one or more network paths may be set “optimized”. If the type of adjustment (identified at step 430) involves decreasing the load on the array port (selected at step 424) may involve setting the LUN-specific priority status of the one or more network paths to “non-optimized”.

Referring to FIG. 5, in some embodiments, a computing device 500 may include processor 502, volatile memory 504 (e.g., RAM), non-volatile memory 506 (e.g., a hard disk drive, a solid-state drive such as a flash drive, a hybrid magnetic and solid-state drive, etc.), graphical user interface (GUI) 508 (e.g., a touchscreen, a display, and so forth) and input/output (I/O) device 520 (e.g., a mouse, a keyboard, etc.). Non-volatile memory 506 stores computer instructions 512, an operating system 516 and data 518 such that, for example, the computer instructions 512 are executed by the processor 502 out of volatile memory 504. Program code may be applied to data entered using an input device of GUI 508 or received from I/O device 520.

FIGS. 1A-5 are provided as an example only. In some embodiments, the term “I/O request” or simply “I/O” may be used to refer to an input or output request. At least some of the steps discussed with respect to FIGS. 1-5 may be performed in a different order or altogether omitted. As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. The acronym RAID, as used throughout the disclosure, means “Redundant Array of Independent Disks”.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method, comprising:
detecting a load-balancing event;
selecting a given array port in a storage system;
selecting a first logical unit number (LUN) in the storage system;
identifying a plurality of host ports in a host device; and
causing a respective LUN-specific priority status of each of the plurality of host ports, with respect to the first LUN, to have a first value, the first value being a value that would cause a path selection software in the host device to choose another array port in the storage system over the given array port for transmission of input-output (I/O) requests originating from any of the plurality of host ports which are directed to the first LUN,
wherein the causing operation is performed by (i) updating a data structure in the storage system to map the first value to each of a plurality of LUN-path pairs, each LUN-path pair including the first LUN and a different respective path that spans between one of the plurality of host ports and the given array port, and (ii) propagating the update to the host device.

2. The method of claim 1, wherein the plurality of host ports includes all ports in the host device from which the first LUN is visible, and the first LUN is hosted on at least one other storage system.

3. The method of claim 1, further comprising:
selecting a second LUN;
setting a respective LUN-specific priority status of at least one of the plurality of host ports to a second value, the second value being a value that would cause the path selection software in the host device to choose the given array port over the other array ports in the storage system for transmission of I/O requests originating from any of the plurality of host ports which are directed to the second LUN.

4. The method of claim 1, wherein the first value is a “non-optimized” value and the second value is an “optimized” value.

5. The method of claim 1, wherein causing a respective LUN-specific priority status of each of the plurality of host ports, with respect to the first LUN, to have a first value includes updating a data structure that is maintained at the storage system to indicate that the priority status of the given array port is set to the first value with respect to the first LUN and each of the plurality of host ports.

6. The method of claim 1, wherein the path selection software in the host device includes a multipath agent.

7. (canceled)

8. The method of claim 1, wherein the host device is coupled to the storage system via a Fibre Channel (FC) network, and the plurality of host ports are identified by reading Fabric Device Management Interface (FDMI) information for the host device from one or more switches in the FC network.

9. The method of claim 1, wherein the LUN is hosted by the storage system and at least one other storage system, and the given array port is selected from a group of ports that includes one or more first ports that are part of the storage system and one or more second ports that are part of the other storage system.

10. A system, comprising:
a memory; and
at least one processor that is operatively coupled to the memory, the at least one processor being configured to perform the operations of:
detecting a load-balancing event;
selecting a given array port in a storage system;
selecting a first logical unit number (LUN) in the storage system;
identifying a plurality of host ports in a host device; and
causing a respective LUN-specific priority status of each of the plurality of host ports, with respect to the first LUN, to have a first value, the first value being a value that would cause a path selection software in the host device to choose another array port in the storage system over the given array port for transmission of input-output (I/O) requests originating from any of the plurality of host ports which are directed to the first LUN,
wherein the causing operation is performed by (i) updating a data structure in the storage system to map the first value to each of a plurality of LUN-path pairs, each LUN-path pair including the first LUN and a different respective path that spans between one of the plurality of host ports and the given array port, and (ii) propagating the update to the host device.

11. The system of claim 10, wherein the plurality of host ports includes all ports in the host device from which the first LUN is visible, and the first LUN is hosted on at least one other storage system.

12. The system of claim 10, wherein the at least one processor is further configured to perform the operations of:
selecting a second LUN;
setting a respective LUN-specific priority status of at least one of the plurality of host ports to a second value, the second value being a value that would cause the path selection software in the host device to choose the given array port over the other array ports in the storage system for transmission of I/O requests originating from any of the plurality of host ports which are directed to the second LUN.

13. The system of claim 10, wherein the first value is a “non-optimized” value and the second value is an “optimized” value.

14. The system of claim 10, wherein causing a respective LUN-specific priority status of each of the plurality of host ports, with respect to the first LUN, to have a first value includes updating a data structure that is maintained at the storage system to indicate that the priority status of the given array port is set to the first value with respect to the first LUN and each of the plurality of host ports.

15. The system of claim 10, wherein the path selection software in the host device includes a multipath agent.

16. (canceled)

17. The system of claim 10, wherein the host device is coupled to the storage system via a Fibre Channel (FC) network, and the plurality of host ports are identified by reading Fabric Device Management Interface (FDMI) information for the host device from one or more switches in the FC network.

18. The system of claim 10, wherein the LUN is hosted by the storage system and at least one other storage system, and the given array port is selected from a group of ports that includes one or more first ports that are part of the storage system and one or more second ports that are part of the other storage system.

19. A non-transitory computer-readable medium storing one or more processor executable instructions, which when executed by at least one processor, cause the at least one processor to perform the operations of:
detecting a load-balancing event;
selecting a given array port in a storage system;
selecting a first logical unit number (LUN) in the storage system;
identifying a plurality of host ports in a host device; and
causing a respective LUN-specific priority status of each of the plurality of host ports, with respect to the first LUN, to have a first value, the first value being a value that would cause a path selection software in the host device to choose another array port in the storage system over the given array port for transmission of input-output (I/O) requests originating from any of the plurality of host ports which are directed to the first LUN,
wherein the causing operation is performed by (i) updating a data structure in the storage system to map the first value to each of a plurality of LUN-path pairs, each LUN-path pair including the first LUN and a different respective path that spans between one of the plurality of host ports and the given array port, and (ii) propagating the update to the host device.

20. The non-transitory computer-readable medium of claim 19, wherein the plurality of host ports includes all ports in the host device from which the first LUN is visible.
